(19) United States
(12) Patent Application Publication
(10) Pub. No.: US 2008/0203934 A1
(43) Pub. Date: Aug. 28, 2008

(54) Method and Circuit for Enabling Dimming Using Triac Dimmer

(75) Inventor: Jos Van Meurs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,685

(22) PCT Filed: May 8, 2006
(86) PCT No.: PCT/IB06/51429

§ 371 Date: Nov. 6, 2007

(30) Foreign Application Priority Data
May 9, 2005 (EP) 05103823.0

(51) Int. Cl. H05B 37/02; H05B 41/36; G05F 1/00

(52) U.S. Cl. 315/224; 315/291; 323/282

(57) ABSTRACT

To enable dimming of an energy-saving lamp, in particular a gas discharge lamp, using a standard TRIAC dimmer circuit, a large additional current is drawn when the TRIAC is in a non-conductive state, and a small additional current is drawn when the TRIAC is in a conductive state. A current control circuit may be connected between the supply voltage and the ballast circuit of the lamp for drawing said additional currents. The current control circuit comprises two switches and a number of resistors for providing a large or a small resistance. In an embodiment, the amount of current drawn is controlled instead of the resistance using additional circuitry in the current control circuit.

The present invention relates to a gas discharge lamp operated by an electronic ballast, and in particular to a method for enabling dimming of a gas discharge lamp using a TRIAC dimmer circuit, a current control circuit and a lamp ballast circuit comprising said current control circuit.

Common standard dimmer circuits employ a TRIAC in order to shape an alternating supply voltage such as a mains voltage. When an alternating supply voltage such as a mains voltage is at a zero crossing, and therefore the current is at a zero crossing, the TRIAC is in a non-conductive state. When the supply voltage increases, a load connected to the dimmer circuit draws current. After a period of time determined by a timing circuit of the TRIAC dimmer circuit, the TRIAC becomes conductive and the lamp is provided with a voltage and a corresponding current. The current keeps the TRIAC in a conductive state until the supply current approaches the zero level again. Said period of time determined by the TRIAC dimmer circuit may be user-adjustable by additional circuitry of the TRIAC dimmer circuit.

A gas discharge lamp operated by an electronic ballast, commonly employed as an energy-saving lamp, only draws current from the supply in the peaks of the alternating voltage due to the presence of a buffer capacitor in the electronic ballast. However, the common TRIAC dimmer circuit is only suitable for use with a resistive load. The load should draw current from the voltage supply during the entire cycle of the alternating voltage in order for the TRIAC dimmer circuit to function properly. Therefore, TRIAC dimmer circuits are commonly used for dimming incandescent lamps. Therefore, dimming an electronic energy-saving gas discharge lamp using a TRIAC dimmer circuit generally does not function correctly.

In U.S. Pat. No. 6,452,343 it is proposed to provide a circuit having a resistive characteristics, e.g. a resistor, between the input terminals of a ballast circuit of a gas discharge lamp. Thus, a TRIAC dimmer circuit is provided with a resistive load and may function properly. However, thereby, a substantial power loss is generated, since a current flows through the resistive circuit at any time. Moreover, when the TRIAC is conductive, only a small current needs to be drawn to keep the TRIAC in its conductive state, whereas when the voltage is near its peak value a large current flows through the resistive circuit.

It is an object of the present invention to provide a method and circuit for operating an electronic gas discharge lamp such that the lamp is dimmable using a TRIAC dimmer circuit with low power loss.

The object is achieved in a method according to claim 1 and a current control circuit according to claim 3.

The method and the circuit advantageously draw a relatively large current, when the electronic gas discharge lamp and its electronic ballast is not drawing current, in order to charge the timing circuit and bring the TRIAC in a conductive state, and draw a reduced current, when only a small current is needed to keep the TRIAC of the dimmer circuit in a conductive state.

When the alternating supply voltage and current increases from zero at a start of a cycle, the TRIAC is in a non-conducting state. To bring the TRIAC in a conducting state, the load should draw current to charge the timing circuit of the TRIAC. Since the electronic gas discharge lamp does not draw current at this stage of the cycle of the alternating voltage and current, the current control circuit is designed to draw current, e.g. by providing a resistive load, when the gas discharge lamp and its ballast circuit are not drawing current.

When the TRIAC has become conductive, only a small current is needed to keep the TRIAC in its conductive state. Therefore, the resistance of the load may be increased, for example. The current control circuit according to the present invention is designed to switch between two branches of a parallel circuit, each branch having a predetermined resistance. The switches are controlled by the voltage level of the supply voltage. When the voltage level is below a predetermined voltage level, the branch having a low resistance is switched conductive. When the voltage level is above the predetermined voltage level, the branch having a high resistance is switched conductive. If the supply voltage is a mains voltage of 230 V at 50 Hz, a suitable predetermined voltage level may be about 50 V.

If the gas discharge lamp and the electronic ballast thereof draw sufficient current to keep the TRIAC in its conductive state, it may not be needed that an additional circuit draws any current. Therefore, in an embodiment, the current control circuit is designed to control the total current drawn by the lamp and the resistive circuit, e.g. by preventing a current from flowing through the resistive circuit when the assembly of the gas discharge lamp and electronic ballast is drawing sufficient current.

In an embodiment the switches are electronic switches such as transistors. In that embodiment, a control terminal of the transistors is operatively connected to the supply voltage. Thus, the level of the supply voltage determines the state of the switches.

In a further embodiment, a third transistor is provided. The third transistor is connected in series to the above-mentioned parallel circuit. A parallel circuit of a capacitor and a zener diode is provided, the parallel circuit being connected to the control terminal of the third transistor and to a voltage source. In this embodiment a first predetermined current level is provided when the supply voltage is below the predetermined voltage and a second predetermined current level is provided when the supply voltage is above the predetermined voltage.

These and other aspects of the present invention will be apparent from and elucidated with reference to the embodiments described hereinafter.

The annexed drawing shows non-limiting exemplary embodiments, wherein:

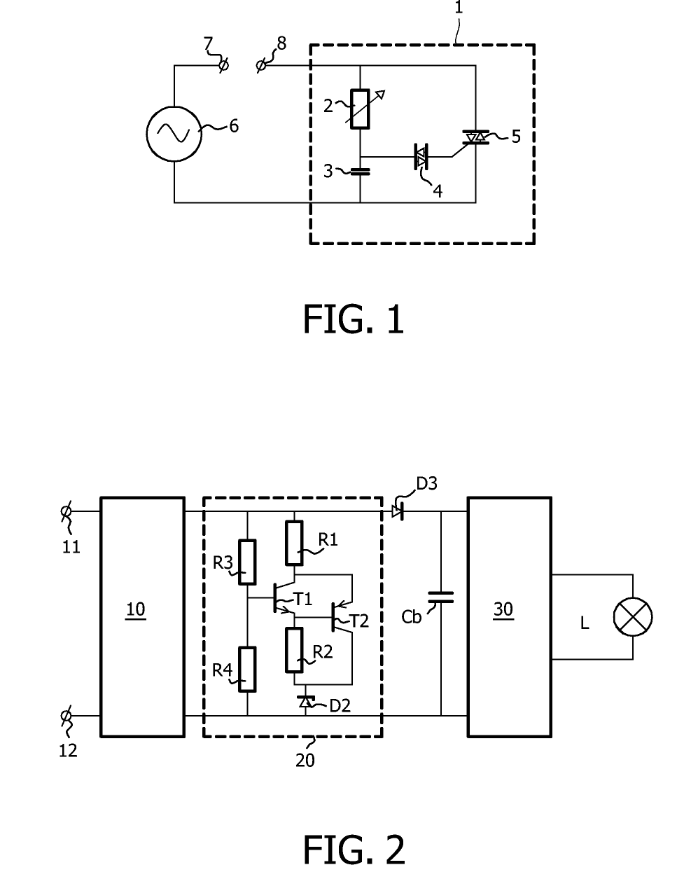

FIG. 1 shows a conventional TRIAC dimmer circuit;

FIG. 2 shows a diagram of an embodiment of a ballast circuit for operating a lamp comprising a current control circuit according to the present invention;

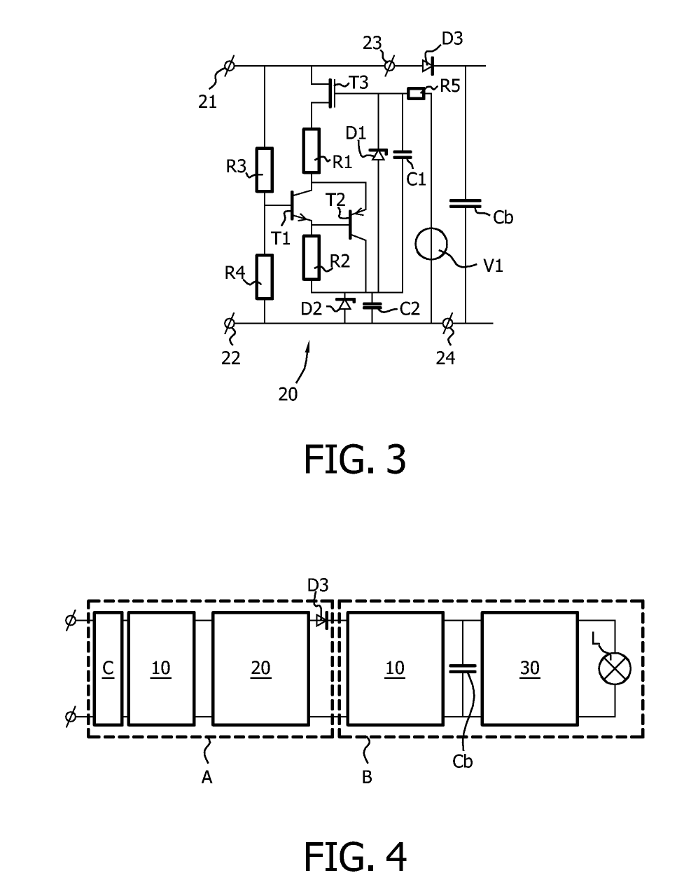

FIG. 3 shows a diagram of another embodiment of the current control circuit according to the present invention; and

FIG. 4 schematically illustrates a combination of a TRIAC dimmer circuit comprising a current control circuit and a commonly available energy-saving lamp.

In the drawings, identical reference numerals indicate similar components or components with a similar function.

FIG. 1 illustrates a conventional TRIAC dimmer circuit suitable for use with the method and circuit according to the present invention. The TRIAC dimmer circuit 1 comprises a resistor 2 having an adjustable resistance, a capacitor 3, a DIAC 4 and a TRIAC 5. A load 6 such as a lamp is connectable between the terminals 7 and 8. The load 6 and the TRIAC dimmer circuit 1 are connected in series to an AC power supply 9. It is noted that the resistor 2 may comprise a resistor having a static resistance and a resistor having a user-adjustable resistance, as is known in the art.

As illustrated the capacitor 3 and the resistor 2 are connected in series between terminals of the TRIAC dimmer circuit 1. The TRIAC 5 is connected in parallel to the series connection of the resistor 2 and the capacitor 3. The DIAC 4 is connected between a control gate of the TRIAC 5 and a node between the capacitor 3 and the resistor 2. The resistor 2 and the capacitor 3 form the timing circuit of the TRIAC dimmer circuit 1.

In operation, when the voltage of the power supply 6 is zero, the DIAC 4 and the TRIAC 5 are in a non-conducting state. With an increasing voltage supplied by the AC power supply 6, the voltage over the capacitor 3 increases. When the voltage over the capacitor 3 reaches the breakover voltage of the DIAC 4, the capacitor 3 is partially discharged by the DIAC 4 into the TRIAC gate. As a result of the current provided to said TRIAC gate the TRIAC 5 becomes conductive. As long as a current flows through the TRIAC 5, the TRIAC 5 stays conductive. When the voltage supplied by the power supply 6 reaches zero again, the TRIAC 5 becomes non-conductive again.

From the above description of the operation a person skilled in the art readily understands that the load needs to draw a current from the TRIAC dimmer circuit 1, i.e. through the series connection of the resistor 2 and the capacitor 3, in order to charge the capacitor 3, when the TRIAC 5 is not conducting, in order to bring the TRIAC 5 in a conductive state.

FIG. 2 illustrates an electronic ballast circuit comprising a rectifier circuit 10, e.g. a diode bridge rectifier circuit, a current control circuit 20 and an inverter circuit 30. Two input terminals 11, 12 of the rectifier circuit 10 may be connected to a low frequency alternating supply voltage such as a mains voltage of 230 V at 50 Hz. The rectifier circuit 10 receives the supply voltage and outputs a rectified supply voltage.

The current control circuit 20 comprises a first resistor R1, a second resistor R2, a first transistor T1 and a second transistor T2. Further, a third and a fourth resistor R3, R4, respectively, are provided to form a voltage divider. A node between the third and the fourth resistor R3, R4 is connected to a control terminal (base) of the first transistor T1. The collector of the first transistor T1 is connected to the first resistor R1, which is also connected to the positive terminal of the supply voltage. The emitter of the first transistor T1 is connected to the second resistor R2, which is also connected to the negative terminal of the supply voltage. A second transistor T2 has its emitter connected to the collector of transistor Ti and its base connected to the emitter of the first transistor T1. A zener diode D2 is connected between the resistor R2, the collector of the transistor T2 and the negative terminal of the supply voltage.

A buffer capacitor Cb flattens the rectified voltage output by the rectifier circuit 10. The inverter circuit 30 is supplied with the rectified and flattened supply voltage and operates on the rectified supply voltage such that an output current of the inverter circuit 30 is suited for operating a gas discharge lamp L, e.g. an energy-saving compact fluorescent lamp.

The current control circuit 20 according to the present invention is provided to draw current from the supply source when the buffer capacitor Cb, the inverter circuit 30 and the gas discharge lamp L are not drawing current from the supply source, in order to enable use of a common, commercially available TRIAC dimmer circuit for dimming of the gas discharge lamp L.

Between the supply voltage source and the input terminals 11, 12 a dimmer circuit for dimming the gas discharge lamp L may be provided. To enable use of a common, commercially available TRIAC dimmer circuit, a current to charge the timing circuit needs to be drawn when the supply voltage on the load is low. Since the inverter circuit 30 only draws current from the supply source when the alternating supply voltage is high due to the presence of the buffer capacitor Cb, no or little current is drawn at the beginning of a cycle of the alternating voltage. Thus, there is not sufficient current drawn to charge the timing circuit of the TRIAC dimmer circuit in order to bring the TRIAC into a conductive state.

When the voltage at the node between the resistors R3 and R4 is high, i.e. above a predetermined level, determined by the zener voltage of the zener diode D2, the first transistor T1 is conductive and a current may flow from the collector to the emitter of transistor T1 and thus through the first and the second resistor R1, R2.

When the voltage at the node between the resistors R3 and R4 is low, i.e. below the predetermined level, the first transistor T1 is non-conductive. The second transistor T2 is conductive when the first transistor T1 is non-conductive. Since the collector of the second transistor T2 is connected to the negative terminal of the supply voltage (via the diode D2), a current may flow through the second transistor T2 and thereby through resistor R1 only. In that case, since the total resistance is low, a large current may flow.

For proper operation of the circuit, a diode D3 may be connected between the buffer capacitor Cb and the current control circuit 20. The diode D3 prevents that a current is drawn from the buffer capacitor Cb, when the supplied voltage, i.e. the output voltage of the rectifier circuit 10, is lower than the voltage over the buffer capacitor Cb. Further, for proper operation, the zener diode D2 may be connected between the negative terminal of the supply voltage and resistor R2/collector of T2 to provide a reference voltage at the emitter of the transistor T1 such that a voltage change at the node between the resistors R3 and R4 results in a switch of the state of the transistor T1.

Thus, selecting suitable values for the resistances of the resistors R1, R2, R3 and R4 and the zener diode D2 assures that a TRIAC dimmer circuit connected between the rectifier circuit 10 and a supply source may function properly.

To ensure that a predetermined amount of current is drawn, the current control circuit 20 may be provided with additional circuitry. Such an embodiment is illustrated in FIG. 3. FIG. 3 illustrates the current control circuit 20 only having input terminals 21 and 22 for receiving a rectified supply voltage and output terminals 23 and 24 for supplying said supply voltage to an inverter circuit 30 as illustrated in FIG. 2.

FIG. 3 shows the circuit illustrated in FIG. 2 comprising the first and the second transistor T1, T2 and the first, second, third and fourth resistors R1-R4. A third transistor T3 (MOSFET) is connected between a positive terminal of the supply voltage and resistor RI. A control terminal of the transistor T3 is connected to a fifth resistor R5 and a voltage source V1. Further, a parallel circuit of a first zener diode DI and a first capacitor C1 is connected to the control terminal of the third transistor T3. A second parallel circuit of a second zener diode D2 and a second capacitor C2 is connected between the negative terminal of the supply voltage and the second resistor R2, the second transistor T2 and the first parallel circuit comprising the first zener diode D1 and the first capacitor C1.

In the embodiment illustrated in FIG. 3 the first capacitor C1 is charged by the voltage source V1 through the fifth resistor R5 until the zener diode D1 limits the voltage. Thus, a predetermined voltage is generated between the control terminal of transistor T3 and the negative terminal of resistor R2 and the emitter of transistor T2. The predetermined voltage is equal to the zener voltage of the zener diode D1 and may be 12 V, for example.

The circuit comprising the first and the second transistors T1 and T2 functions similarly to the embodiment of FIG. 2. The conductive state of the first and the second transistors T1 and T2 is determined by the voltage at the node between the resistors R3 and R4 and the zener voltage of the zener diode D2. Therefore, when the voltage at the node between the resistors R3 and R4 is low, the second transistor T2 is conductive and the current drawn is substantially equal to the zener voltage of diode D1 over the resistance of resistor R1 (I=V_{D1}/R1). When the voltage at the node between the resistors R3 and R4 is high, the first transistor Ti is conductive and the current drawn is substantially equal to the zener voltage of diode D1 over the sum of the resistance of resistor R1 and the resistance of resistor R2 (I=V_{D1}/(R1+R2)).

In an embodiment for use with a mains voltage of 230 V at 50 Hz, the zener voltage of the diode D1 may be 12 V and the resistance of the resistor R1 may be 180 ohm and the resistance of the second resistor R2 may be 2200 ohm. In that embodiment, a current of about 5 mA (12 V/2380 ohm) is drawn when the supply voltage is above the predetermined voltage level, and a current of about 66 mA (12 V/180 ohm) is drawn when the supply voltage is below the predetermined voltage level. It is noted that a current flows as well through the voltage divider comprising the resistors R3 and R4. However, this current may be selected to be insignificantly small compared to the current through resistors R1 and R2 by selecting the resistances of the resistors R3 and R4 high.

The diode D3 is provided to prevent that current is drawn from the buffer capacitor Cb instead of being drawn from the voltage supply source, in particular a TRIAC dimmer circuit in series with said supply source, connected to terminals 21 and 22.

In an embodiment, the voltage source V1 may be omitted and replaced by a voltage received from the inverter circuit connected to the current control circuit. For example, the inverter circuit is supplied with a flattened half-sine wave rectified voltage using the buffer capacitor Cb. Connecting resistor R5 to such a flattened DC voltage may provide a suitable voltage.

FIG. 4 schematically illustrates a TRIAC dimmer circuit assembly A connected to an electronic gas discharge lamp B. The electronic gas discharge lamp B comprises an electronic ballast circuit having a rectifier circuit 10, a buffer capacitor Cb and an inverter circuit 30 connected to a gas discharge lamp L. The TRIAC dimmer circuit assembly A comprises a standard common TRIAC dimmer circuit C for dimming a lamp having a resistive characteristic and a rectifier circuit 10, a current control circuit 20 and a diode D3.

The electronic gas discharge lamp B as shown in FIG. 4 is a commonly available energy-saving lamp that may be connected directly to a mains voltage and is not dimmable using a standard TRIAC dimmer circuit. The TRIAC dimmer circuit assembly A comprises such a standard TRIAC dimmer circuit C and further comprises a current control circuit 20 according to the present invention, e.g. as shown in FIG. 2 or FIG. 3. For proper operation of the current control circuit 20, a rectifier circuit 10 and the diode D3 are as well provided in the TRIAC dimmer circuit assembly A. Thus, a simple TRIAC dimmer circuit assembly A may be provided with the use of which a common energy-saving lamp B, having an electronic ballast circuit, may be dimmed.

A person skilled in the art readily recognizes that the rectifier circuit 10 comprised in the electronic gas discharge lamp B is redundant in the circuit assembly of FIG. 4, since the voltage provided to the lamp assembly B is already rectified by the rectifier circuit 10 of the dimmer assembly A. The skilled person, therefore, also recognizes that the dimmer circuit assembly A may as well be employed in combination with an energy-saving lamp B having an electronic ballast without the rectifier circuit 10.

1. Method for operating an electronic gas discharge lamp, the method enabling dimming of the gas discharge lamp using a TRIAC dimmer circuit (1), the method comprising:
drawing a relatively large current from the dimmer circuit (1) when the TRIAC (5) is in a non-conductive state to bring the TRIAC (5) in the conductive state;
characterized in that the method further comprises:
reducing the current drawn from the dimmer circuit (1) when the TRIAC (5) is in a conductive state.

2. Method according to claim 1, wherein the relatively large current is drawn from the dimmer circuit (1) by connecting a small resistance between the output terminals (7,8) and the current is reduced by connecting a large resistance between output terminals (7,8).

3. Current control circuit (20) for controlling a current drawn from a voltage power source (6), the circuit comprising a first series connection of a first resistive circuit (R1) and a parallel circuit of
a first switch (T2); and
a second series connection of a second switch (T1) and a second resistive circuit (R2), the first and the second switch (T1, T2) being controlled by the voltage supplied by the voltage power source (6) such that the first switch (T2) is conductive when the supply voltage is below a predetermined level and the second switch (T1) is conductive when the supply voltage is above the predetermined level.

4. Current control circuit according to claim 3, wherein the first and the second switch (T1, T2) are transistors, a control terminal of the transistors (T1, T2) being operatively connected to the supply voltage.

5. Current control circuit according to claim 4, wherein a third transistor (T3) is provided, the third transistor (T3) being connected in series to the first series connection, and a parallel circuit of a capacitor (C1) and a zener diode (D1) being connected to the control terminal of the third transistor (T3) and to a voltage source (V1).

6. Ballast circuit for operating a gas discharge lamp, the ballast circuit comprising a rectifier circuit (10) for receiving a low frequency alternating voltage, an inverter circuit (30) for providing a high frequency lamp current, and a current control circuit (20) according to claim 3, connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

7. Assembly of a gas discharge lamp (L) and a ballast circuit according to claim 6.

8. Dimmer circuit for dimming an electronic gas discharge lamp (L), the dimmer circuit comprising a TRIAC dimmer circuit (1), a current control circuit (20) according to claim 3 and a rectifier circuit (10) connected between the TRIAC dimmer circuit (1) and the current control circuit (20).
